(19) United States
(12) Patent Application Publication
(10) Pub. No.: US 2010/0027921 A1
(43) Pub. Date: Feb. 4, 2010

(54) LOCKING DEVICE CAPABLE OF SECURING A BAG TO AN OBJECT AND/OR IN A CLOSED CONFIGURATION

(76) Inventors: Mary Thomson, North East, MD (US); Ann L. Keller, Bensalem, PA (US); Kathleen Parisi, Bensalem, PA (US)

Correspondence Address: Ryder, Lu, Mazzeo and Konieczny, LLC, 107 NORTH BROAD STREET, SUITE 109, DOYLESTOWN, PA, 18901, US

(21) Appl. No.: 12/577,956

(22) Filed: Oct. 13, 2009

Related U.S. Application Data
(63) Continuation-in-part of application No. 12/421,595, filed on May 6, 2009, now Pat. No. 7,621,160.
Application No. 12/421,595 is a continuation-in-part of application No. 12/135,030, filed on Jun. 6, 2008, now abandoned.
Application No. 12/135,030 is a continuation-in-part of application No. 11/973,244, filed on Oct. 5, 2007, now abandoned.

(51) Int. Cl. B65D 33/16; E05B 65/52; A44B 19/00; B65D 30/08

(52) U.S. Cl. 383/64; 70/64; 24/381; 383/109

(57) ABSTRACT

A locking mechanism to secure both a zipper used to seal an opening of a bag in a closed configuration and a cable integrated into the bag to secure the bag to an object is disclosed. The locking mechanism may include a pin housing to receive a pin secured to an end of the cable, a thumb tab to secure a zipper head thereto, and a lock to lock the thumb tab and the pin housing in a secure configuration. The locking mechanism may provide a single control to conveniently release both the zipper and the cable. The lock may disengage the thumb tab and the thumb tab may disengage the pin housing. The lock may disengage the thumb tab or the pin housing based on the way the lock is unlocked. The bag may be made of a material that is resistant to cutting and gouging.

### CROSS REFERENCES TO RELATED APPLICATIONS

This application is a continuation-in-part of U.S. patent application Ser. No. 12/421,595 filed on May 6, 2009, which is continuation-in-part of U.S. patent application Ser. No. 12/135,030, filed on Jun. 6, 2008, which is continuation-in-part of U.S. patent application Ser. No. 11/973,244, filed on Oct. 5, 2007 (now abandoned). U.S. application Ser. Nos. 11/973,244, 12/135,030 and 12/421,595, are incorporated herein in their entirety by reference as if set forth at length.

### FIELD OF THE INVENTION

The present invention relates generally to an apparatus for securing both a zipper used to seal an opening of a bag in a closed configuration to protect the contents within the bag and a cable integrated into the bag, where the cable can be secured around an object to secure the bag to the object.

### BACKGROUND

People use bags (e.g., handbags, backpacks, brief cases, computer bags) to store and carry various items. The items within a bag may include personal items (e.g., pictures, identification) and/or valuable items (e.g., cash, phones, computers). People may bring a bag to various different locations (e.g., work, school, gym, vacation). If an individual lost or had their bag or the contents of the bag stolen the individual may suffer financial and emotional hardships.

Accordingly, the individual may want to keep the bag with them at all times. However, in some situations carrying the bag is burdensome or not possible (e.g., involved in sporting event, going swimming, entering a location that doesn't permit bags). In these situations the individual may attempt to hide the bag somewhere or place the bag down and keep an eye on it. However, thieves are very observant and operate quickly and discretely. If the bag is left alone, even for a short period of time or even in close proximity to the individual, a thief may take the bag or some or all of the contents from the bag.

One can deter thieves by locking the bag to prevent access to the contents and possibly securing the bag to an object to make it harder to steal the bag and/or contents. Thieves may avoid bags that are secured in some fashion and look for easier targets to avoid drawing attention to themselves. However, if it is not easy or is time consuming individuals may opt to not secure their bags. Accordingly, what is needed is a bag that has the capability of locking the bag and/or securing the bag to an object in a fashion that is fast, easy, and convenient.

### SUMMARY

A locking mechanism is disclosed that is capable of being used in bags that use sliding fasteners (e.g., zippers) to provide access to at least one compartment and also include a cable integrated therein for securing to an object. The locking mechanism is capable of locking the zipper in a closed configuration and is also capable of locking a free end of the cable to the bag.

The bag that the locking mechanism may be utilized in includes a sliding fastener (zipper) and a cable that can be used to secure the bag to an object and may act as a handle. The bag (liner) may be made of a material that is resistant to cutting and gouging (e.g., Kevlar), which may make the bag almost impossible to penetrate by ordinary means. The liner may also be made of a water-resistant material to allow the contents of the bag to remain dry. The bag may include one or more compartments for storing contents and may include the zipper on at least one of the compartments. The cable may be integrated into the bag and have one end that is permanently secured thereto and another end that is removably connected thereto. The cable may wrap around an object and then the removable end may be locked to the bag to secure the bag to the object. The cable may be a galvanized coated cable (e.g., ⅛″). The cable may act as a handle for the bag and may be contained within a material (e.g., fabric, leather) to provide a more aesthetic look and for comfort. The cable may have a pin secured to the removable end and the pin may be used to secure the cable to the bag.

The locking mechanism may include a pin housing for securing the pin at the end of the cable, a thumb tab for securing a head of the zipper, and a lock (e.g., pin tumbler) for securing the pin housing and the thumb tab in a locked state. The locking mechanism may enable the zipper and/or the cable to be in a locked state.

The bag provides the desired security and convenience by enabling a user to quickly lock or unlock both the cable and the sliding fastener. The user may elect to lock the sliding fastener, the cable, or both, depending on the situation. For example, when carrying the bag, it may be desirable to lock the cable and utilize the cable as a handle, but leave the sliding fastener unlocked for convenient access to the items contained within the bag. When leaving the bag unattended, it may be desirable to lock both the cable and the sliding fastener to secure the bag, as well as its contents. The cable may be arranged about an object to secure the bag to that object. For example, the cable may be secured around a rail, such as that provided by a fence post, to secure the bag to that rail while it is left unattended. The bag may be secured to a variety of stationary or non-stationary objects, including, but not limited to, a tree, a picnic table, beach umbrella, lounge chair, office desk, baby stroller and shopping cart, to name a few. The user is able to “lock and leave” the bag and enjoy time with family and friends.

The applications for the bag are practically limitless, and include but are not limited to the following: vacation and business travel, water activities, children's activities including sports activities, shopping, activities involving babies, work, school and dorm room security and laptop security. These advantages, and others, will be apparent from the following detailed description.

### BRIEF DESCRIPTION OF THE DRAWINGS

The structure, operation, and advantages of the present invention will become further apparent upon consideration of the following description taken in conjunction with the accompanying figures. The figures are intended to be illustrative, not limiting. For illustrative clarity, certain elements in some of the figures may be omitted, or illustrated not-to-scale, and cross-sectional views may be in the form of “slices”, or “near-sighted” cross-sectional views, omitting certain background lines which would otherwise be visible in a “true” cross-sectional view.

FIG. 1A-F illustrate side views of an example locking bag in various configurations, according to one embodiment;

FIGS. 2A-B illustrate a simplified top and side view of an example locking mechanism, according to one embodiment;

FIGS. 3A-C illustrate a series of cross-sectional views of an example locking mechanism in use, according to one embodiment;

FIG. 4A-C illustrate several views of an example locking mechanism, according to one embodiment;

FIG. 5A illustrates several views of an example upper housing of a locking mechanism, according to one embodiment;

FIG. 5B illustrates several views of an example thumb tab of a locking mechanism, according to one embodiment;

FIGS. 6A-C illustrate cross-sectional views of example locking mechanisms, according to one embodiment;

FIG. 7 illustrates a top cross-sectional view of an example locking mechanism, according to one embodiment; and

FIG. 8 illustrates a side cross-sectional view of an example locking mechanism, according to one embodiment.

### DETAILED DESCRIPTION

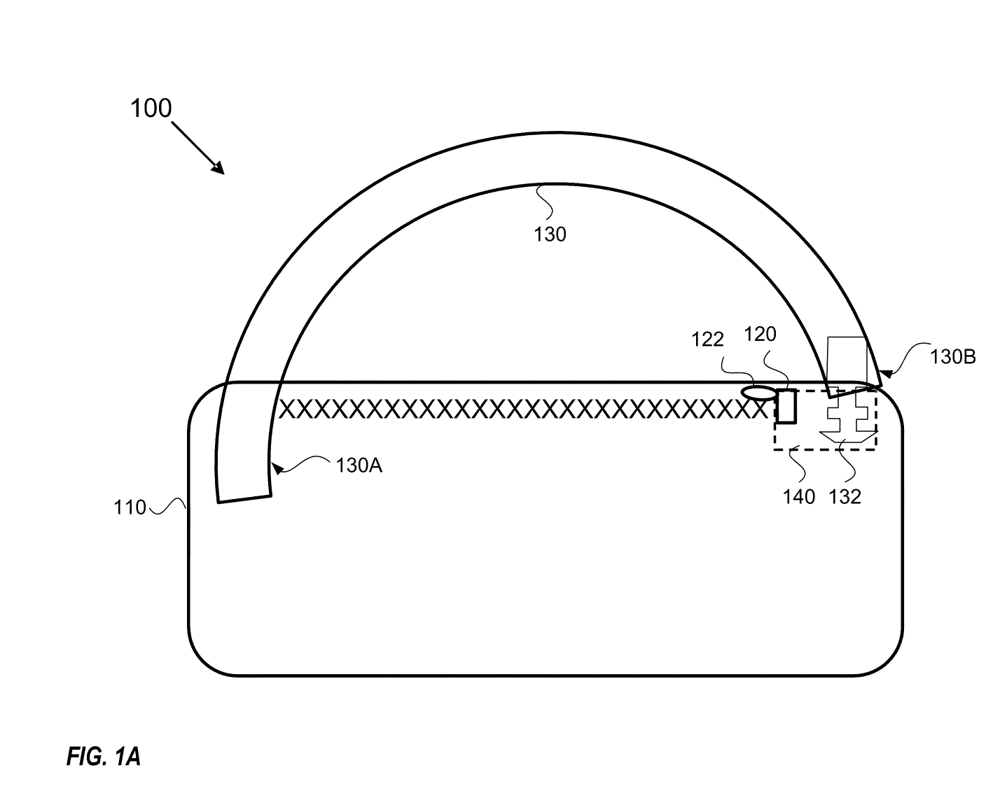

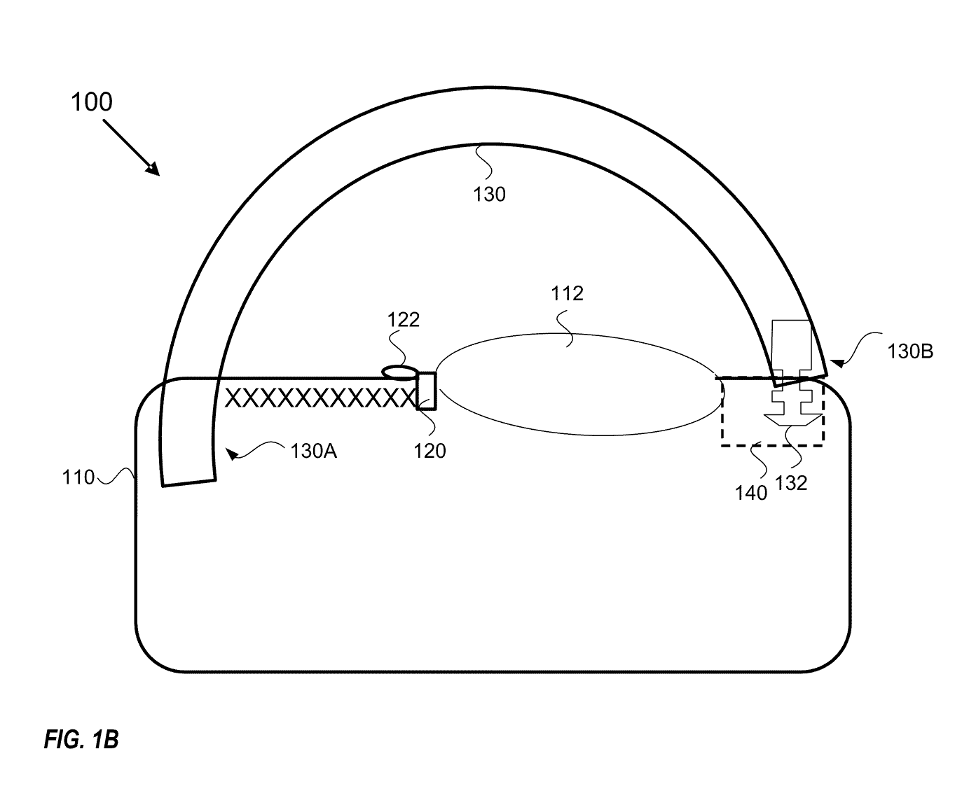

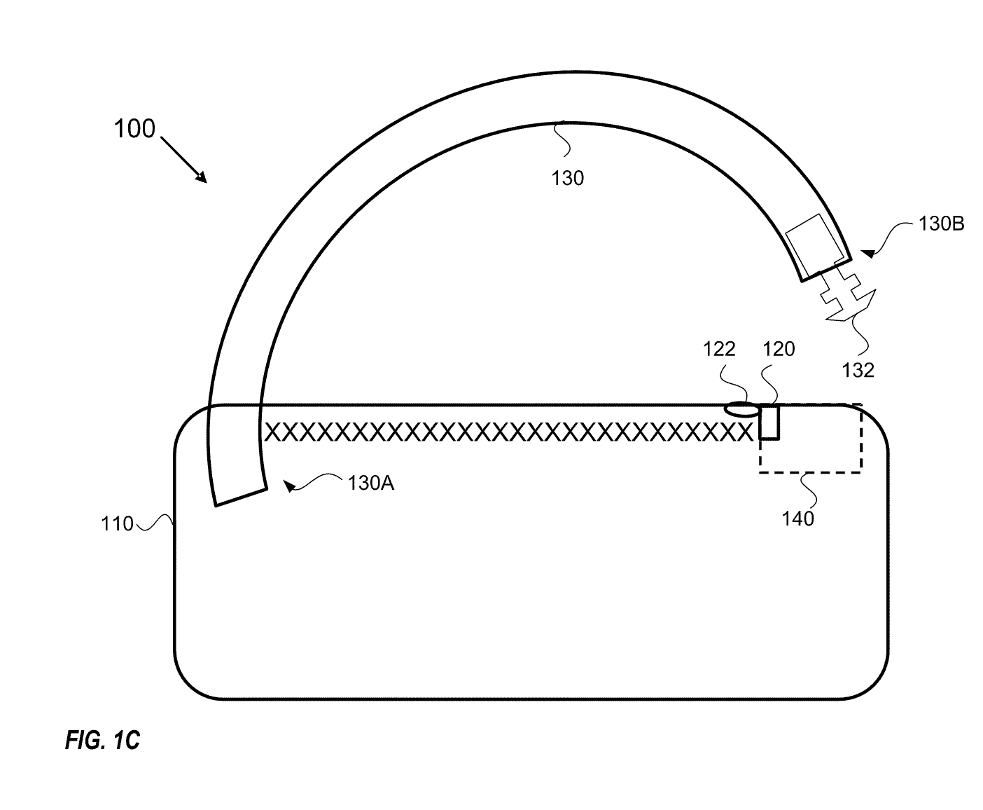

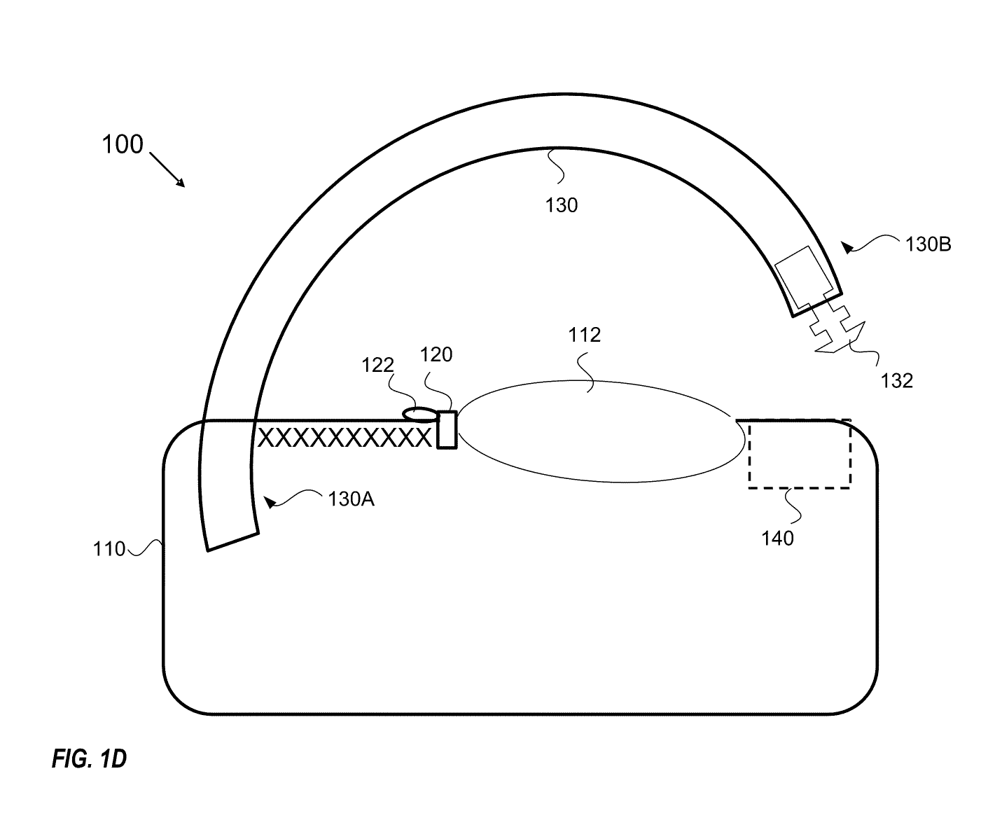

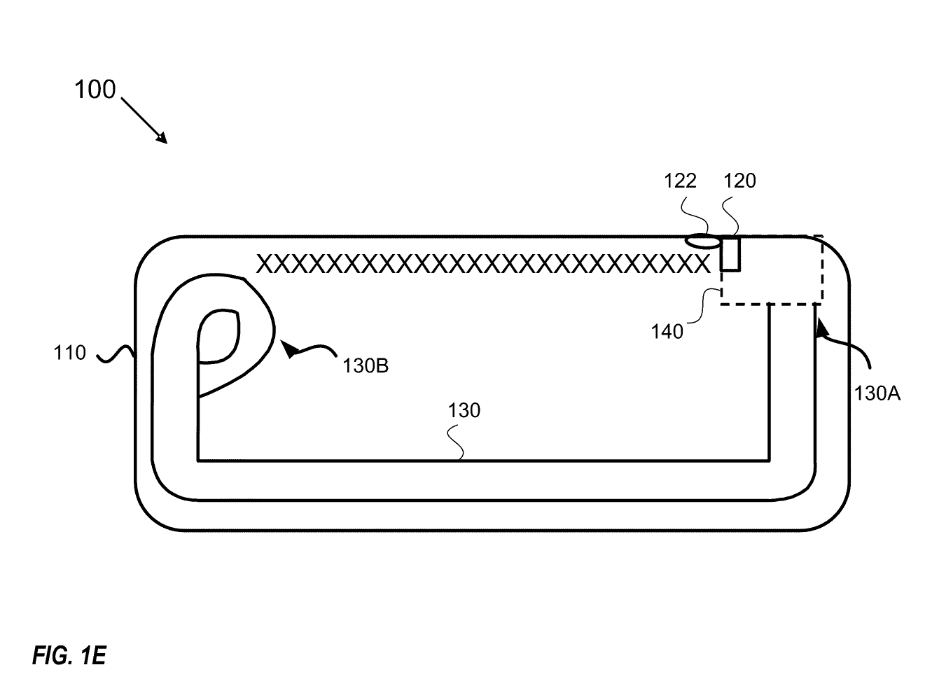

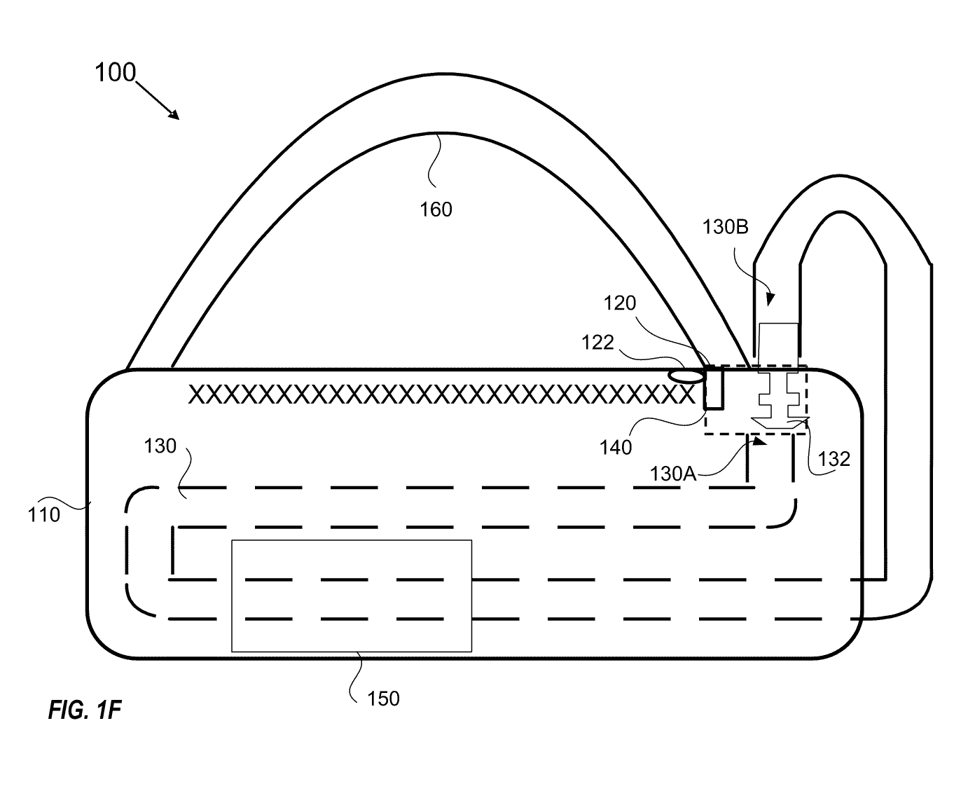

FIGS. 1A-E illustrate side views of an example locking bag 100 in various configurations. The locking bag 100 includes a main body 110 having at least one compartment (not illustrated) for holding contents. The main body 110 may be made of a material that is resistant to cutting and gouging, such as KEVLAR®. The main body 110 may be made of a material that is water-resistant, such as a water-resistant polyester fabric. The main body 110 may have an outer layer and an inner layer (liner). The liner may be secured to only the edges of the outer layer so that the liner is a floating liner. The floating liner may make it harder for one to secure both layers at once in an attempt to cut and/or gauge the bag 100. According to one embodiment, the liner is made of a tear resistant material, such as a material made of Aramid fibers (class of heat-resistant and strong synthetic fibers). The outer layer of the bag 100 may be made of a material that is selected for the use of the bag 100. For example, for a beach bag the outer layer may be a high grade canvas like material, for a back pack the outer layer may be a nylon material, and for a brief case the outer layer may be leather.

The main body 110 includes an opening 112 (illustrated in FIGS. 1B and 1D that show an open/partially open configuration) to allow entry thereinto, for example, to place contents in or remove contents from. The main body 110 may include one or more interior pockets (not illustrated) and/or one or more exterior pockets (not illustrated). The one or more interior/exterior pockets may be made of a water-resistant material, providing contents contained therein protection from water damage.

The locking bag 100 may include a sliding fastener, such as a zipper, (not illustrated in the side view) to open and close the opening in the main body 110. The zipper may include strips of interlocking teeth on each side of the opening that are pulled together and interlocked when closed. The zipper may include a sliding head 120 that connects and secures the two sides of the zipper together or releases the two sides (depending on whether opening or closing the zipper). The zipper may also include a pull tab 122 connected to the sliding head 120 that can be grabbed by a user. The pull tab 122 may be rotatable around the sliding head 120 so that it can be used to pull the sliding head 120 in either direction. As illustrated, when the sliding head 120 is moved to the right the zipper is closed and the main body 110 is sealed and when it is moved to the right the zipper is opened and access to the main body 110 is provided.

The locking bag 100 may include a cable 130 integrated therein for securing the locking bag 100 to an object. The cable 130 may be made of a strong, yet flexible material (e.g., a galvanized steel cable) and my be coated with plastic, or be disposed within a fabric sleeve (not illustrated). According to one embodiment, the cable 130 may have a ⅛ inch diameter to provide the necessary strength without being too large. The size of any cable 130 used is in no way intended to be limited to a specific size or grade. The cable 130 may have a permanent end 130A and removable end 130B. The permanent end 130A may be permanently fixed to the main body 110 using various means including but not limited to glue, sewing, screws, rivets, or welding. The permanent end 130A may be located between an outer layer and an inner layer (liner) of the main body 110. The removable end 130B may be secured to or removed from the main body 110. The removable end 130B may include a pin 132 secured thereto by swaging, or other means to provide a strong attachment. The pin 132 may be used to secure the handle to the main body 110 and may include a plurality of detents as a means for securing. The means for securing the removable end 130B will be discussed in more detail later.

When the cable 130 is not be used to secure the bag 100 to an object it may be hidden from view in the main body 110 (e.g., compartment, internal pocket, external pocket). The cable 130 may be tucked into the main body 110 or retracted. Alternatively, the cable 130 may be secured to the main body 110 even when the cable 130 is not used to secure the bag 100 to an object. The cable 130 may be utilized as a handle, possibly a handle used to carry the bag 100. If used as a handle, the cable 130 may be contained within a material (e.g., fabric, leather) to provide a more aesthetic look and for comfort.

The locking bag 100 may include a locking mechanism 140 that may lock the removable end 130B of the cable 130 to the main body 110 and/or lock the zipper (e.g., sliding head 120 and/or pull tab 122) in a closed configuration. The locking mechanism 140 is simply illustrated as a box at this point for ease of illustration but will be discussed in more detail later. The locking mechanism 140 may be secured to the main body 110 using various means including but not limited to glue, sewing, screws, rivets, or cables. According to one embodiment, the locking mechanism 140 may be in a reinforcing panel (not illustrated) that is connected (e.g., sewn) to the main body 110.

Locking the removable end 130B of the cable 130 to the main body 110 enables the bag 100 to be secured to a variety of stationary or non-stationary objects (e.g., a tree, a table, a chair, a desk, a baby stroller, a shopping cart) by placing the handle 120 around the object prior to locking to the main body 110 via the locking mechanism 140. Locking the zipper in a closed configuration secures the contents of the main body 110 therewithin.

FIG. 1A illustrates the locking bag 100 in a configuration in which both the zipper and the cable 130 are secured in place (locked) by the locking mechanism 140. The XXXs in FIGS. 1A-F are to indicate that the portion of the zipper that is closed. This configuration could be used, for example, when you are carrying the bag 100 (e.g., using the cable 130 as a handle to hold) or have the bag 100 secured to an object and want the contents of the main body 110 secured (locked).

FIG. 1B illustrates the locking bag 100 in a configuration in which the zipper is unlocked and open while the cable 130 is secured in place (locked) by the locking mechanism 140. The open zipper provides access to the opening 112 in the main body 110. This configuration could be used, for example, when you are carrying the bag 100 (possibly using the cable 130 as a handle) and want access to the contents of the main body 110 or when you have the bag 100 secured to an object (e.g., stroller) but want access to the contents of the main body 110.

FIG. 1C illustrates the locking bag 100 in a configuration in which the zipper is closed and locked by the locking mechanism 140 while the removable end 130B of the cable 130 is unsecured (not connected to the locking mechanism 140) and is removed from the main body 110. This configuration could be used, for example, when you want the contents of the main body 110 secured (locked) but do not need the cable 130 to lock the bag 100 to an object or use it as a handle.

FIG. 1D illustrates the locking bag 100 in a configuration in which the zipper and the cable 130 are unlocked, the zipper is open, and the removable end the 130B of cable 130 is removed from the main body 110. This configuration could be used, for example, when you don't need the cable 130 to secure the bag 100 to an object or use it as a handle, and when you want access to the main body 110 to put in or take out contents.

FIG. 1E illustrates the locking bag 100 in a configuration in the second end 130B of the cable 130 is unsecured (not connected to the locking mechanism 140) and the cable 130 is housed (e.g., coiled) within the main body 110 (e.g., compartment, internal pocket, external pocket) so as to be hidden from view, rather then remain dangling from the main body 110 (as illustrated in FIGS. 1C and 1D). While not illustrated, the cable 130 may be housed in an internal or external compartment or pocket and the main body 110 may include a means for winding or retracting the cable 130.

The permanent end 130A of the cable 130 may be housed within the main body 110 (e.g., secured along an exterior of the main body, housed between an outer layer and a lining) and permanently secured (e.g., integrated into, welded) to the locking mechanism 140. Securing the cable 130 and the permanent end 130A in this fashion enables the cable 130 to create a continuous loop when the removable end is secured to the locking mechanism 140. The continuous loop provides additional support and security then simply securing the permanent end 130A to the main body 110 in close proximity to the point where the cable 130 exits the main body 110 (as illustrated in FIGS. 1A-1D).

FIG. 1F illustrates the locking bag 100 in a configuration in which the permanent end 130A of the cable 130 is permanently secured to the locking mechanism 140 but is otherwise free to be routed internal or external to the main body 110. As illustrated, the cable 130 is woven though certain contents 150 (e.g., a computer, a gun) within the main body 110 and then is routed external to the main body 110 and the removable end 130B is connected to the locking mechanism 140. By routing the cable 130 through the contents 150 additional security can be provided to the contents 150.

This embodiment illustrates the zipper being locked as well as the cable 130 but is not limited thereto. Rather you could use the cable 130 to lock certain contents 150 to the main body 110 and possibly the main body 110 to an object while leaving the zipper unlocked so as to provide access to other contents therein (e.g., provide access to books with the main body 110 but have computer secured).

This embodiment also illustrates that the cable 130 need not be located on the same side as the zipper (as illustrated in FIGS. 1A-1E) or be aligned with or associated with the zipper in any fashion other then utilizing the locking mechanism 140. The locking bag 100 may also include a handle 160 separate and apart from the cable 130 for carrying the bag 100. In this embodiment the handle 160 is on the same side and is in alignment with the zipper but is not limited thereto.

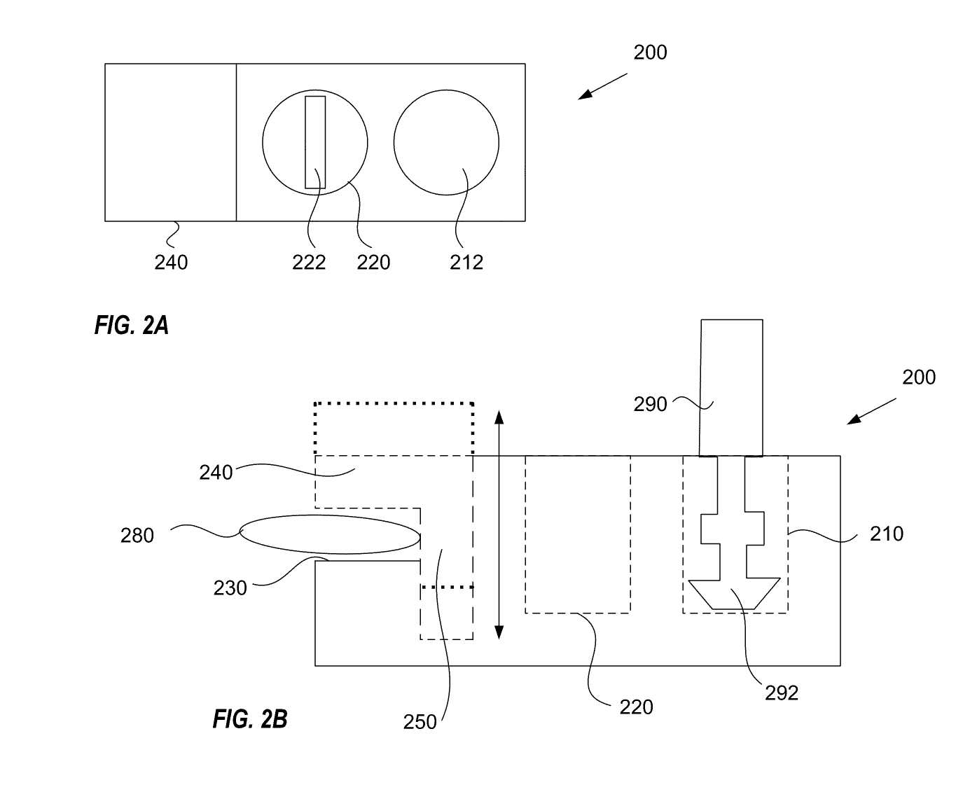

FIGS. 2A-B illustrate a simplified top and cross sectional side view of an example locking mechanism 200 (e.g., 140 of FIGS. 1A-F). The locking mechanism 200 may be capable of securing a cable (e.g. 130 of FIGS. 1A-F) to the main body (e.g., 110 of FIGS. 1A-F), a zipper in a closed configuration, or both by locking the zipper, the cable or both in place. The locking mechanism 200 may include a cable securing portion, a zipper securing portion, and a locking portion where the various portions engage and interact with one another to lock the zipper, the cable or both in place.

The handle securing portion of the locking mechanism 200 may include a pin housing 210 to secure a pin 292 secured to an end of the cable 290 therein. The pin 292 may be inserted in the pin housing 210 through a pin port 212. The pin housing 210 may be a cam that includes teeth that when the cam is closed engage in indents with the pin 292 to lock the pin 292 in the housing 210. As illustrated, the pin 292 has two indents and the pin housing 210 would include two sets of teeth (not illustrated) to engage the indents. The number of indents and teeth is not limited to two. Preferably the number of indents and teeth would be greater than one for redundancy to ensure that a failure on one teeth indent pair would not result in the pin 292 dislodging from the pin housing 210 when not desired. The pin housing 210 and pin 292 are not limited to the illustrated embodiment.

The zipper securing portion of the locking mechanism 200 may include a zipper head receptacle 230 for receiving a zipper head 280 (e.g., sliding head 120, sliding head 120 and pull tab 122 of FIGS. 1A-F) and a thumb tab 240 for securing the zipper head 280 to the receptacle 230. The thumb tab 240 may include a shaft 250 that can be moved up and down within the locking mechanism 200. When the shaft 250 is moved down the thumb tab 240 may secure the zipper head 280 to the receptacle 230 and when the shaft 250 is moved up the zipper head 280 may be removed from the locking mechanism 200.

The locking portion of the locking mechanism 200 may include a lock 220, such as a key activated lock, and may include a key slot 222 to receive a key. The lock 220 may be a multiple pin tumbler (e.g., 7 pin) key-operated lock. The lock 220 may be located between the thumb tab 240 and the pin housing 210. The lock 220 may be used to secure (lock) the shaft 250 in a down position so that the thumb tab 240 secures the zipper head 280 to the zipper head receptacle 230. The lock 220 may also be used to lock the teeth of the pin housing 210 within the indents of the pin 292 to secure the handle 290 therein. FIGS. 2A-B do not show the interaction between the pin housing 210, the lock 220, and the shaft 250 for ease of illustration. The interaction of these components will be discussed in more detail below.

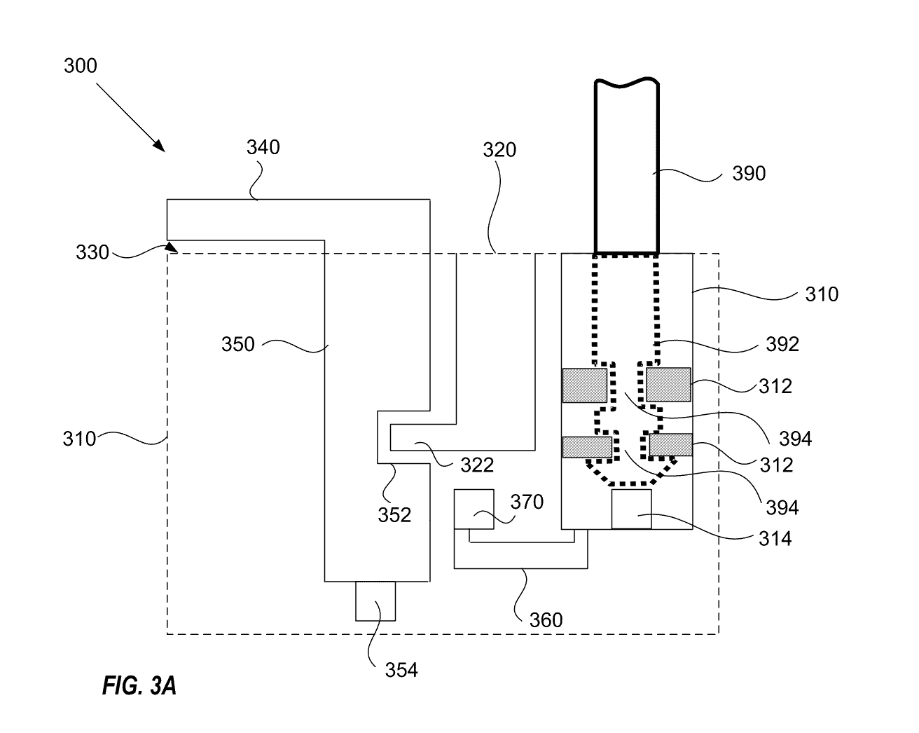

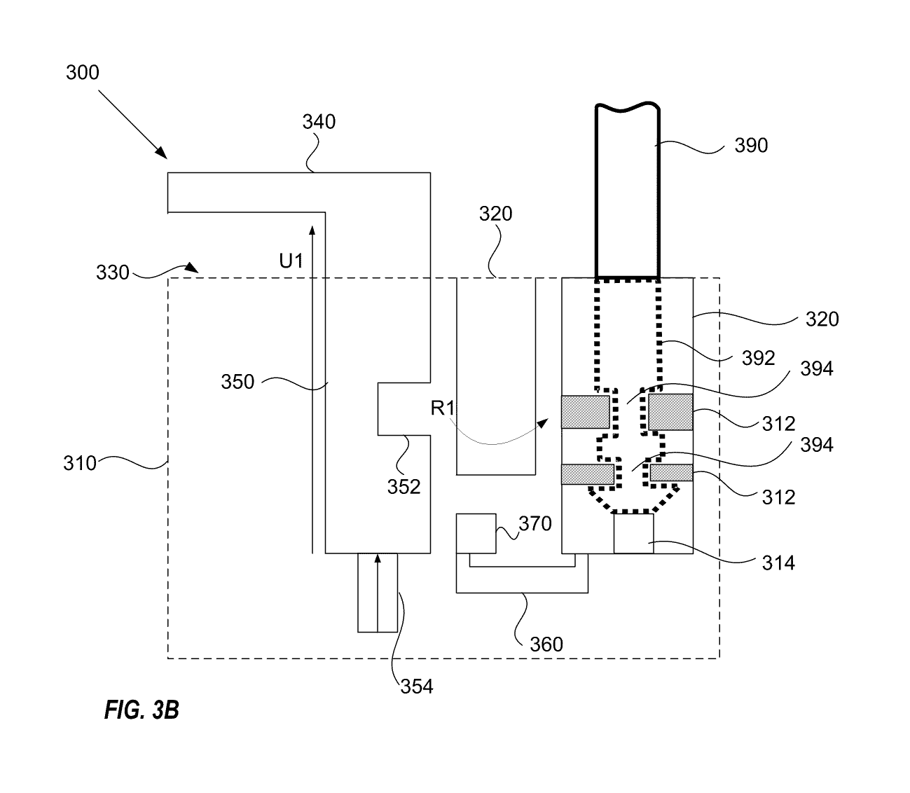

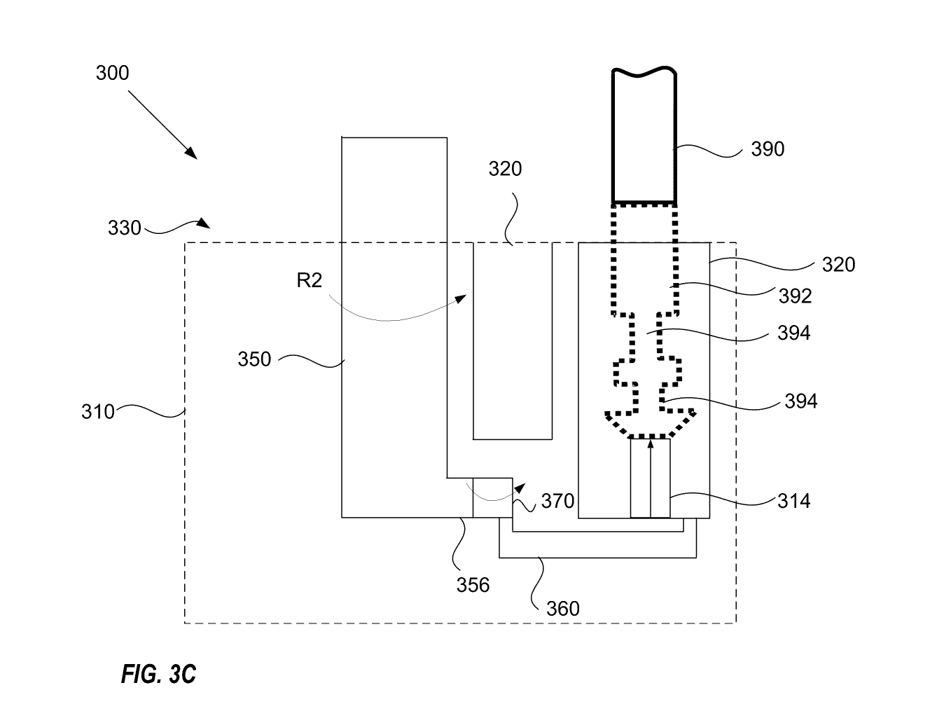

FIGS. 3A-C illustrate a series of cross-sectional views of an example locking mechanism 300 (e.g., 140, 200) in use. The locking mechanism 300 may include a housing 305 that the various components are contained within. The locking mechanism 300 may include a pin housing 310, a lock 320 and a thumb tab 340. The housing 305 may have a zipper head receptacle 330 formed therein to receive a zipper head (not illustrated).

The pin housing 310 may be used to receive a pin 392 that is secured to the removable end of the handle 390. The pin housing 310 may be a cam that has teeth 312 formed on the interior walls that can be rotated and positioned by rotating the cam. The pin 392 may have indents 394 that the teeth 312 may be positioned to fit within when the pin 392 is in the pin housing 310. When the cam is rotated one way the teeth 312 may be within the indents 394 and the pin 392 is secured in the pin housing 310. When the cam is rotated the other way the teeth 312 may be removed from the indents 394 so that the pin 392 can be removed from the pin housing 310. An arm (barrel paddle) 360 may connect to and rotate the pin housing 310 to engage and disengage the teeth 312 in the indents 394. A spring mechanism 314 may be included in the housing 310 or below the housing 310 and may be released when the pin housing 310 is rotated so that the teeth 312 and indents 394 are not engaged. The spring mechanism 314 may eject the pin 392 from the pin housing 310.

The lock 320 may be a key activated lock, such as a multiple pin tumbler (e.g., 7 pin). The lock 320 may include hook 322 on one end that is used to engage the shaft 350 and lock the shaft 350 in place when the lock 320 is in a locked configuration.

The thumb tab 340 may include a shaft 350 within the housing 305 that may be used to lock the thumb tab 340 in place and move the thumb tab 340. The shaft 350 may include a groove 352 formed therein for receiving the hook 322, and an engagement edge 356 formed in a lower edge to engage arm a cam 370 to rotate the arm 360. A spring mechanism 354 may be included as part of the thumb tab 340 or may be located below the shaft 350 and may be released when the hook 322 is rotated out of the groove 352. The spring mechanism 354 may push the shaft 350 up so that the thumb tab 340 is lifted from the zipper head receptacle 330.

FIG. 3A illustrates the locking mechanism 300 in a configuration where the zipper and the cable could be locked if they were inserted accordingly. The pin housing 320 is rotated such that the teeth 312 and within the indents 394. The hook 322 is engaged with the groove 352 so that the shaft 350 is locked in a down configuration where the zipper head (not illustrated) could be secured between the zipper head receptacle 330 and the thumb tab 340.

FIG. 3B illustrates the locking mechanism 300 in a configuration where the zipper head may be released. The lock 320 was unlocked and rotated, for example in the direction R1, so that the hook (not illustrated as it may be protruding out of FIG.) is no longer engaged with the groove 352. As the shaft 350 is no longer locked in place the spring 354 may be released to push the shaft 350 upward, for example in the direction U1, so that the thumb tab 340 is lifted from the zipper head receptacle 330 and the zipper head can be removed and the zipper can be opened.

FIG. 3C illustrates the locking mechanism 300 in a configuration where the pin 392 may be released (or ejected) from the pin housing 320. Once the thumb tab (not visible in this view as it may be protruding out of FIG.) is extended out of the housing 305 it can be rotated, for example in the direction R2, and the shaft 350 will rotate as well. When the shaft 350 is rotated the engagement edge 356 may engage the cam 370 and cause the cam 370 to rotate. The rotating cam 370 may move the arm 360 which in turn may rotate the pin housing 310 (cam) so that the teeth 312 and no longer engaged within the indents 394. As the teeth 312 are no longer engaged within the indents 394, the spring 314 may be released to push the pin 392 out of the pin housing 310.

For the sake of clarity, FIGS. 3A-C do not illustrate all details associated with the operation of the locking mechanism 300. Furthermore, the locking mechanism 300 and the various components of the locking mechanism 300 are not limited to the illustrated embodiments. One skilled in the art would recognize that changes could be made without departing from the current scope.

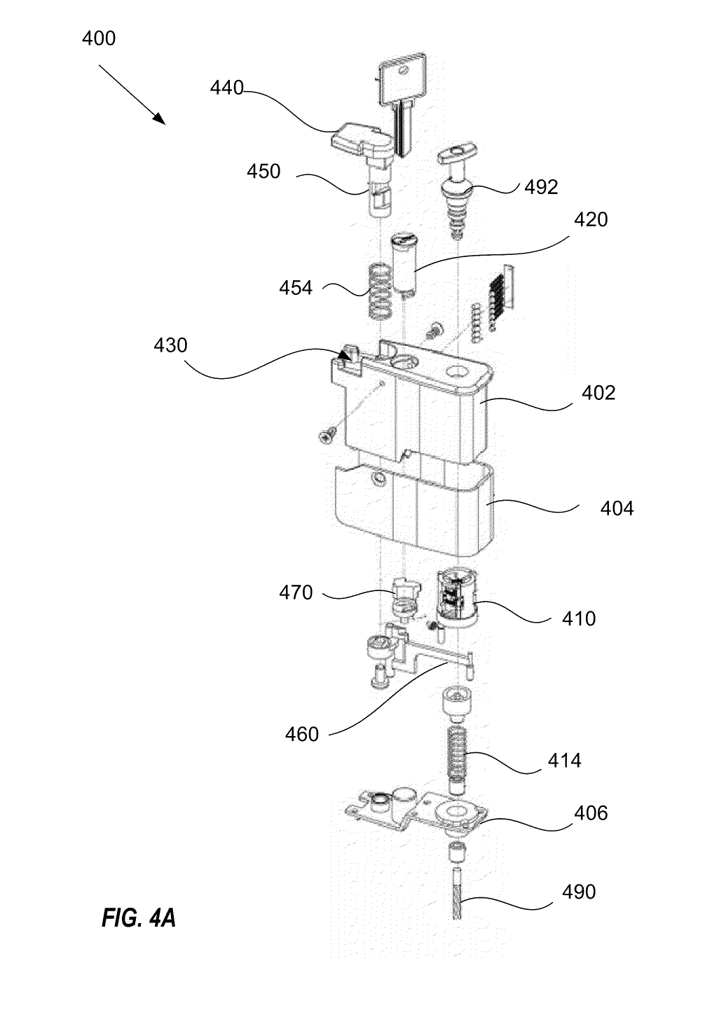

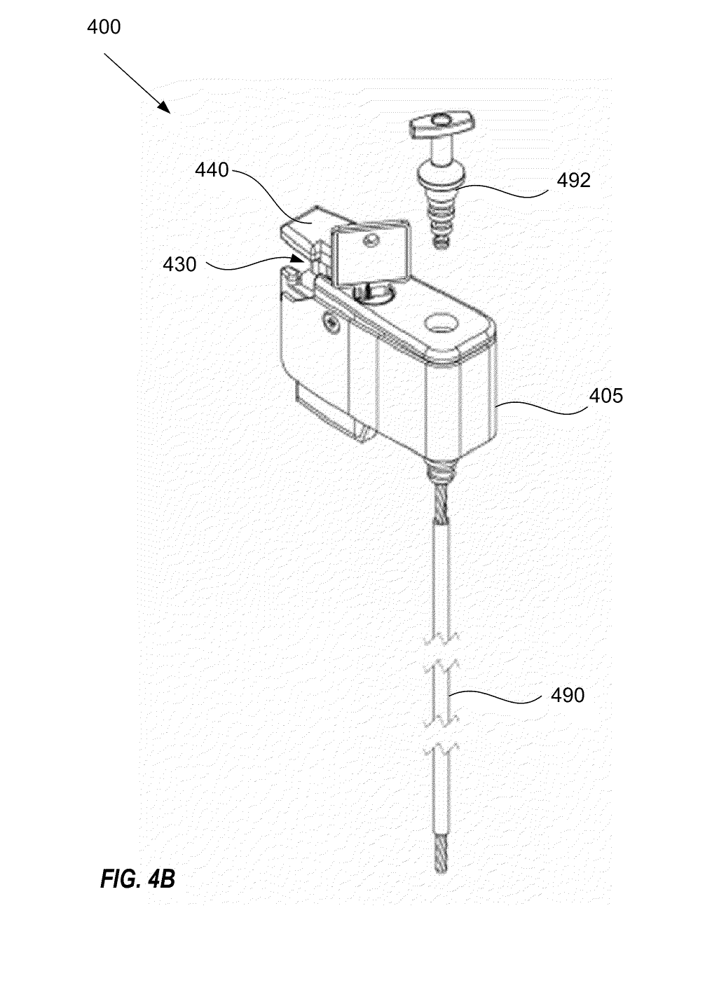

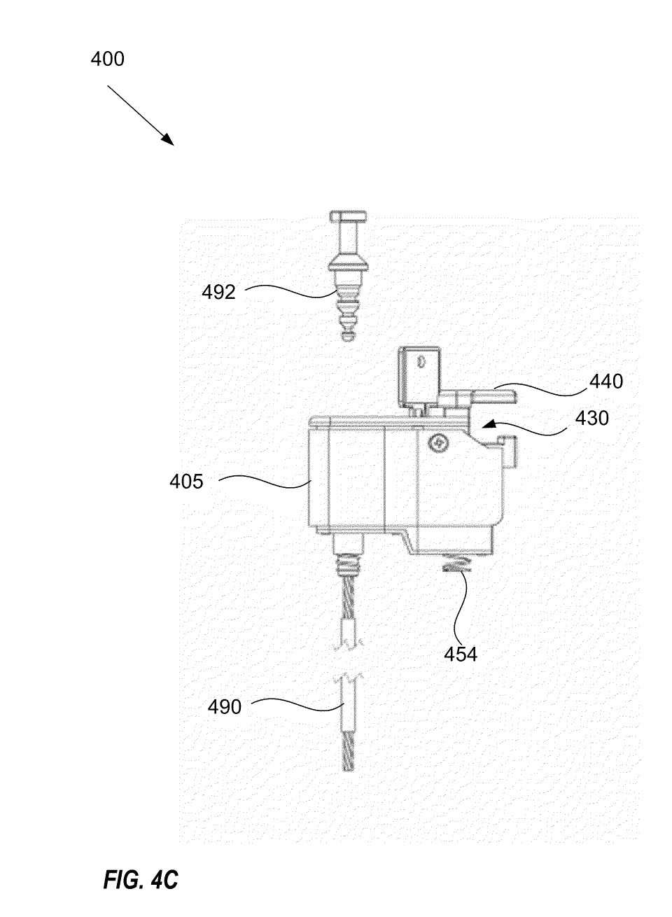

FIGS. 4A-C illustrate various views of an example locking mechanism 400 (e.g., 140, 200, 300) in detail. The locking mechanism 400 has a housing 405 that include an upper section 402, a lower section 404 and a bottom plate 406. The upper section of the housing 406 has a zipper head receptacle 430 formed therein. A pin housing 410, lock 420, shaft 450 of the thumb tab 440, arm (barrel paddle) 460, and cam 470 are enclosed within the housing 405. A spring 414 may be located below the pin housing 410 and a spring 454 may be located below the shaft 450. The locking mechanism 400 operates in the same or a similar fashion to that described with respect to FIGS. 3A-C.

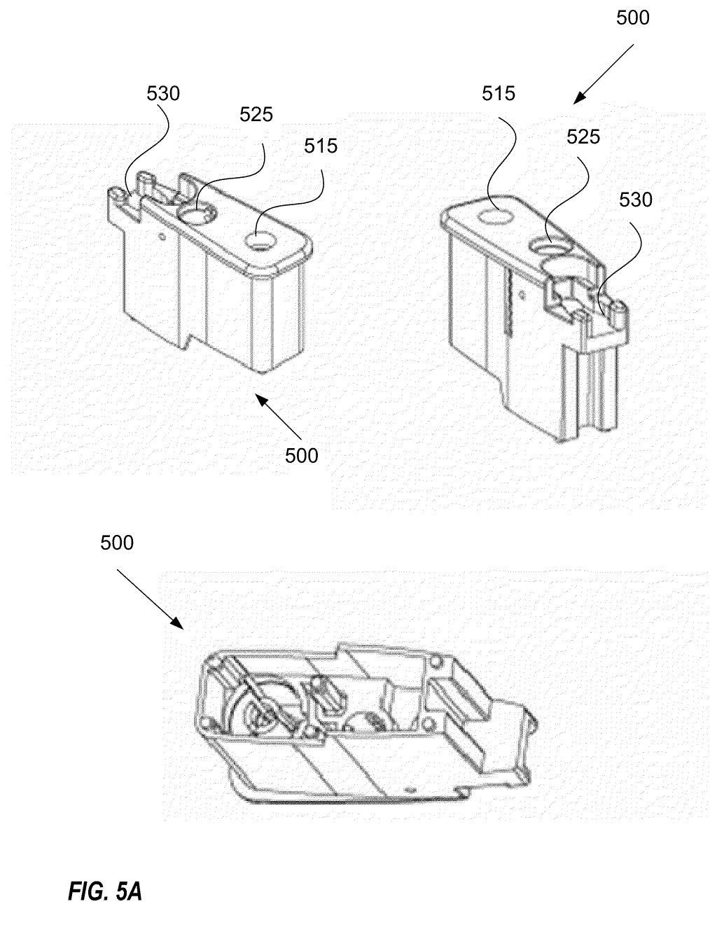

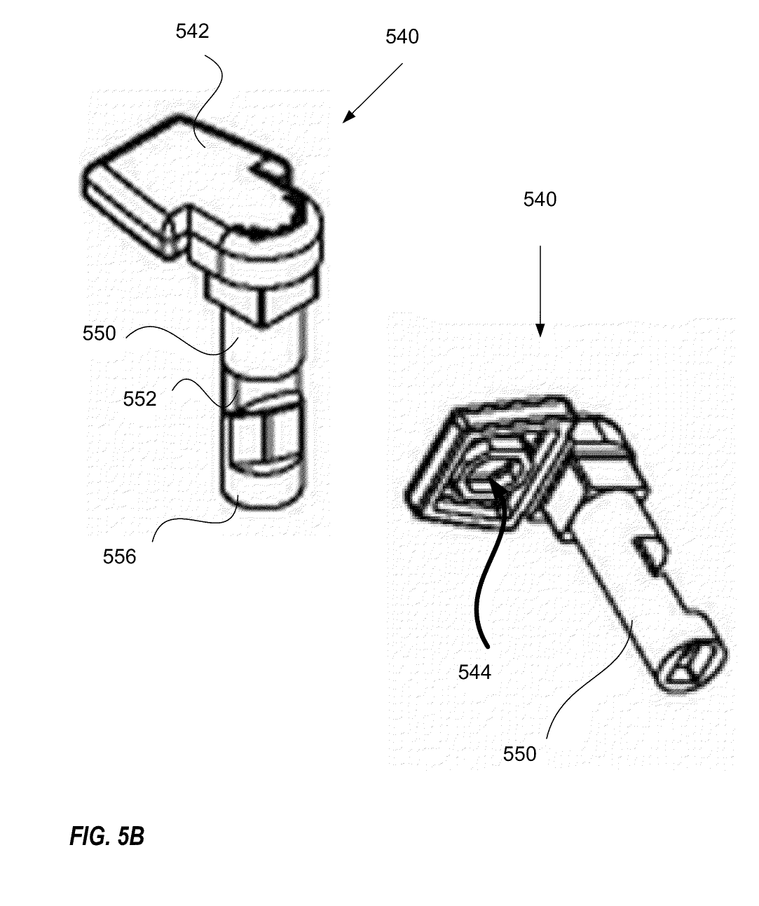

FIG. 5A illustrates various detailed views of an example upper housing 500 (e.g., 402 of FIG. 4) used in a locking mechanism. The upper housing 500 may include zipper head receptacle 530 formed therein, a hole 515 to expose the opening of the pin housing and to receive the pin within the pin housing, and a hole 525 to expose the key slot in the lock and to received the key. The thumb tab may reside on the zipper head receptacle 530 when in a locked configuration and above the zipper head receptacle 530 in an open configuration.

FIG. 5B illustrates various detailed views of an example thumb tab 540 (e.g., 440 of FIGS. 4A-C) used in a locking mechanism. The thumb tab 540 may include an upper portion 542 and a shaft 550. The shaft 550 may include a groove 552 to receive a hook of the lock when in the lock is locked and to lock the thumb tab 540 in a locked configuration. The shaft 550 may also include an engagement edge 556 that engages a cam that is used to open the pin housing when the lock is unlocked and the thumb tab 540 is rotated. The under side of the upper portion 542 of the thumb tab 540 may include a receiving means (zipper head lid) 544 to receive the zipper head when the thumb tab is in a locked configuration and secure the zipper head therein.

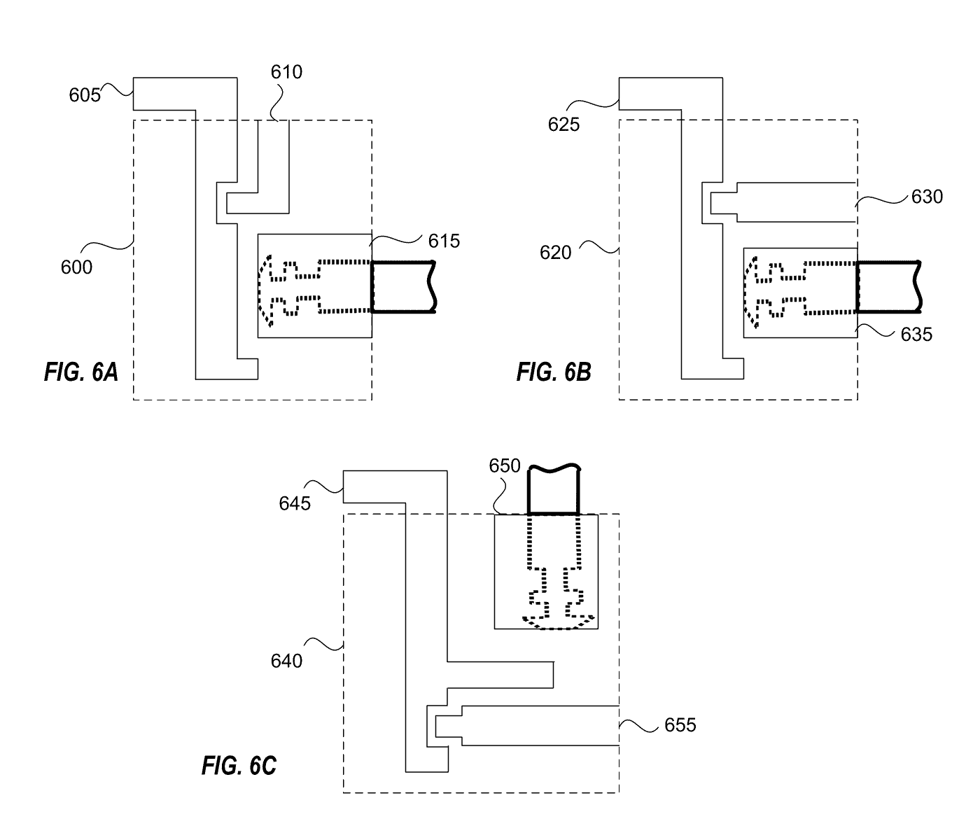

FIGS. 6A-C illustrate cross-sectional views of example locking mechanisms. FIG. 6A illustrates a locking mechanism 600 wherein a zipper locking shaft 605 and a lock 610 are on the top of the locking mechanism 600 while a pin housing 615 is on the side. This embodiment enables the cable to be inserted from the side rather than the top. FIG. 6B illustrates a locking mechanism 620 wherein a zipper locking shaft 625 is located on the top of the locking mechanism 620 while a lock 630 and a pin housing 635 are on the side. This embodiment enables the cable to be inserted and the device to be locked from the side rather than the top. FIG. 6C illustrates a locking mechanism 640 wherein a zipper locking shaft 645 and a pin housing 650 are located on the top of the locking mechanism 620 while a lock 655 is on the side. This embodiment enables the device to be locked from the side rather than the top. The exact details regarding the interaction of the devices may vary.

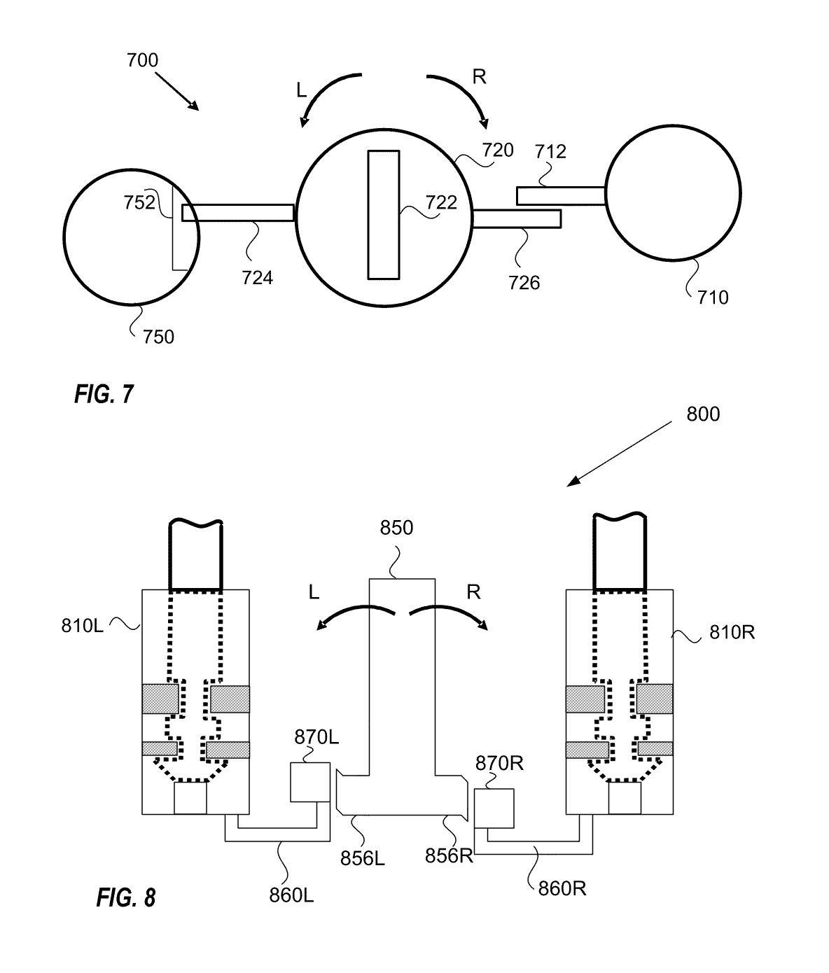

FIG. 7 illustrates a top cross sectional view of an example locking mechanism 700. The locking mechanism 700 may include a pin housing 710, a lock 720, and zipper locking shaft 750 and. The lock 720 may include a key slot 722 and flanges 724, 726 on each side thereof. The zipper locking shaft 750 may include a groove 752 formed therein. The pin housing may include an arm 712 connected thereto. A key may be inserted in the lock 720 and enable the lock 720 to move in either direction and enable the user can to unlock either the cable or the zipper depending on which way the key is turned.

For example, when the key is turned to the right (direction indicated by arrow labeled “R”) the flange 724 that was within the groove 752 may disengage from the groove 752 and enable shaft 750 to move (e.g., upwards). The flange 726 may rotate away from the arm 712 so have no impact on the pin housing 710. When the key is turned to the left (direction indicated by arrow labeled “L”) the flange 726 may engage the arm 712 causing the housing 710 to rotate and the teeth to disengage the indents and enable the pin and cable to be removed. The flange 724 may rotate within the groove 752 so have no impact on the shaft 750.

With this embodiment, the user can conveniently unlock the fastener head separately from the handle. If the user desires to unlock both the fastener head and the handle, this can be easily achieved by turning the key in one direction, followed by the opposite direction. For example, by turning the key right, and then left, both the fastener head and the handle are conveniently released.

FIG. 8 illustrates a top cross sectional view of an example locking mechanism 800. The locking mechanism 800 may include two pin housing 810R, 810L, a lock (not visible in this view), a zipper locking shaft 850 (thumb tab not visible in this view), two arms (barrel paddles) 860R, 860L, and two cams 870R, 870R. The zipper locking shaft 850 may have two engagement edges 856R, 856R. After the zipper locking shaft 850 is released from the lock the shaft 850 may be rotated in either direction. If the shaft 850 is rotated to the right the engagement edge 856R contacts the cam 870R causing the cam 870R to rotate and move the arm 860R and open the pin housing 810R. If the shaft 850 is rotated to the left the engagement edge 856L contacts the cam 870L causing the cam 870L to rotate and move the arm 860L and open the pin housing 810L.

With this embodiment, the user can conveniently eject one of two cables after the thumb tab and shaft 850 head has been unlocked. If the user desires to unlock both the cables, this can be easily achieved by turning the thumb tab and shaft 850 in one direction, followed by the opposite direction.

Although the invention has been illustrated by reference to specific embodiments, it will be apparent that various changes and modifications may be made. Reference to “one embodiment” or “an embodiment” means that a particular feature, structure or characteristic described in connection with the invention is included in at least one embodiment. Thus, the appearances of the phrase “in one embodiment” or “in an embodiment” appearing in various places throughout the specification are not necessarily all referring to the same embodiment.

It will be understood that the present invention may have various other embodiments. Furthermore, while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given. The invention is intended to be protected broadly within the spirit and scope of the appended claims.

What is claimed is:

1. A locking mechanism utilized with a bag having a zipper disposed on an opening thereto to open or close the bag and a cable having a first end permanently attached to the bag and a second end having a pin connected thereto, the locking mechanism comprising
a housing;
a pin housing to receive the pin connected to the second end of the cable and to secure the pin therein,
a thumb tab to secure a zipper head to the housing when the zipper is closed; and
a lock to secure the thumb tab and the pin housing in a secured configuration, wherein the thumb tab and the pin housing are individually actuated from the secured configuration to individually release the zipper and the pin.

2. The locking mechanism of claim 1, wherein the housing includes a zipper head receptacle to receive the zipper head and the thumb tab is to secure the zipper head to the zipper head receptacle.

3. The locking mechanism of claim 1, wherein the pin includes indents and the pin housing includes teeth that engage the indents to secure the pin in the pin housing.

4. The locking mechanism of claim 3, wherein the pin housing is a cam and rotating the pin housing rotates location of the teeth between a secured configuration where the teeth engage the indents to a released configuration where the teeth disengage from the indents.

5. The locking mechanism of claim 4, wherein the pin housing includes a spring and when the pin housing is rotated to the released configuration the spring is actuated and expels the pin from the pin housing.

6. The locking mechanism of claim 4, wherein the lock is to rotate the pin housing.

7. The locking mechanism of claim 4, wherein the thumb tab is to rotate the pin housing.

8. The locking mechanism of claim 1, wherein the thumb tab includes a shaft to move up and down within the housing to release and secure the zipper head from and to the housing.

9. The locking mechanism of claim 8, wherein the lock includes a hook and the shaft includes a groove, and wherein when the thumb tab is in a down position and the lock is in a locked configuration the hook will engage the groove and secure the thumb tab in the down position.

10. The locking mechanism of claim 9, wherein the thumb tab further includes a spring and when the lock is unlocked so the pin is disengaged from the groove, the spring is actuated and propels the shaft upward and the thumb tab disengages from the housing.

11. The locking mechanism of claim 1, wherein the thumb tab includes a zipper head lid to receive the zipper head.

12. A locking bag comprising:
a bag to store contents therein, wherein the bag includes at least one compartment having an opening;
a zipper including two sets of interlocking teeth configured and disposed on opposite ends of the opening and a zipper head in communication with the two sets of interlocking teeth to engage the teeth to close the opening and disengage the teeth to open the opening;
a cable having a first end permanently secured to the bag and a second end having a pin connected thereto; and
a locking mechanism including a housing, a pin housing to receive the pin connected to the second end of the cable and to secure the pin therein, a thumb tab to secure a zipper head to the housing when the zipper is closed, and a lock to secure the thumb tab and the pin housing in a locked configuration, wherein the thumb tab and the pin housing are individually actuated from the locked configuration to individually release the zipper and the pin.

13. The locking bag of claim 12, wherein the pin includes indents and the pin housing includes teeth and a spring, wherein when the pin is inserted in the pin housing and the pin housing is in the locked configuration the teeth engage the indents to secure the pin therein, and when the pin housing is switched to an unlocked configuration the teeth are disengaged from the indents and the spring is actuated to expel the pin from the pin housing.

14. The locking bag of claim 12, wherein the thumb tab includes a shaft and a spring, wherein the shaft includes a groove formed therein and the lock includes a hook, wherein when the thumb tab is in a down position and the lock is in a locked configuration the hook will engage the groove and secure the thumb tab in the down position, and wherein when the lock is unlocked so the pin is disengaged from the groove, the spring is actuated and propels the shaft upward and the thumb tab disengages from the housing.

15. The locking bag of claim 12, further comprising an arm coupled between the thumb tab and the pin housing, wherein when the thumb tab is in an unlocked configuration it is free to rotate, wherein when the thumb tab is rotated it engages the arm and causes the arm to move, wherein when the arm moves it causes the pin housing to disengage and release the pin.

16. The locking bag of claim 12, wherein the lock includes a pair of engagement arms, wherein if the lock is opened in a first direction a first engagement arm actuates the pin housing to release the pin, and wherein if the lock is opened in a second direction a second engagement arm actuates the thumb tab to release the zipper head.

17. The locking bag of claim 12, wherein the bag includes a floating liner made of a material that is resistant to cutting and gouging.

18. A locking bag comprising:
a bag, having at least one opening, to store contents therein;
a zipper including two sets of interlocking teeth configured and disposed on opposite ends of one of the at least one openings and a zipper head in communication with the two sets of interlocking teeth to engage the teeth to close the one of the at least one openings and disengage the teeth to open the one of the at least one openings;
a cable having a first end permanently secured to the bag and a second end having a pin connected thereto; and
a locking mechanism including a zipper head receptacle, a pin housing, a thumb tab, and a lock, wherein the zipper head receptacle is to receive the zipper head when the zipper is closed, the pin housing is to receive the pin and to secure the pin therein when the pin housing is in a locked configuration, the thumb tab is to secure the zipper head within the zipper head receptacle when the thumb tab is in a locked configuration, and the lock is to secure the thumb tab and the pin housing in their locked configurations when the lock is engaged, wherein the thumb tab includes a shaft to move up and down within the locking mechanism when the lock is disengaged and the thumb tab is in a unlocked configuration, and wherein when the shaft is in an up position the shaft is to rotate to switch the pin housing to an unlocked configuration.

19. The locking bag of claim 18, wherein
the thumb tab includes a spring that is actuated and propels the shaft upward when the lock is disengaged and the thumb tab is in a unlocked configuration; and
the pin housing includes a spring that is actuated to expel the pin from the pin housing when the pin housing is switched to an unlocked configuration.

20. The locking bag of claim 18, wherein the bag includes a floating liner made of a material that is resistant to cutting and gouging.
